(19) United States
(12) Patent Application Publication
(10) Pub. No.: US 2009/0019748 A1
(43) Pub. Date: Jan. 22, 2009

(54) MOBILE DISPLAY SYSTEM AND METHOD

(75) Inventor: Paul Rosarius, Oviedo, FL (US)

Correspondence Address: EDWARD M. LIVINGSTON, PA, 963 TRAIL TERRACE DRIVE, NAPLES, FL, 34103, US

(73) Assignee: Palm Tree Mobile Billboards, Inc.

(21) Appl. No.: 11/779,117

(22) Filed: Jul. 17, 2007

(51) Int. Cl. G09F 21/04; G06F 7/00

(52) U.S. Cl. 40/591; 701/36

(57) ABSTRACT

A mobile display system (1) and method which utilizes a plurality of light emitting diodes (LED's) (29) to create a display (6) located on a side (3 and/or 30) and/or rear section (5) and/or front section (44) of a vehicle (2). The vehicle (2) has a first side (3), a second side (30), a rear section (5), a front section (44), a bottom section (33) and a top section (4). A means for powering (37) the at least one display (6) may be batteries (38), at least one generator (39), the motor (40) of the vehicle (2), solar panels (43) and other power supply means.

### BACKGROUND OF THE INVENTION

This invention relates to displays systems, more particularly, a mobile display system and method that permits a user to show a display, which may be an advertisement, logo, information and the like, on a vehicle to a large quantity of individuals wherein the display may be quickly and easily changed.

Currently, traditional billboards are commonly used as a method of showing a display, such as an advertisement, logo, information and the like, to individuals. The billboard is placed along the side of a road, preferably a heavily-trafficked highway, so as to show a display to a large quantity of individuals. However, most billboards are static as the display has no movement. Thus, if the individual or entity utilizing the billboard desires to change the display, the entire display must be removed and replaced.

Recently, however, rotating motion billboards have become more prevalent in the public. The rotating motion billboards typically have a plurality of segments wherein each segment has a plurality of sides, most commonly three sides per segment. Each side has a portion of the display located thereon such that when the rotating motion billboard rotates, a plurality of sides form the display. Thus, an individual or entity may display a plurality of displays on a single billboard.

However, although the use of the rotating motion billboards permits a greater amount of displays to be shown on a billboard, the amount of displays is still limited according to the number of sides per segment. As such, if an individual or entity chooses to change one display, he/she/it must still remove the display from each segment, which can be costly. In addition, although the rotating motion billboard is variable in a sense that a plurality of displays may be shown, the billboard is still static in a sense that the rotating motion billboard is located in one predetermined location.

Thus, a need exists for a mobile display system and method that permits a user to show a display, which may be an advertisement, logo, information and the like, on a vehicle to a large quantity of individuals wherein the display may be quickly and easily changed.

The relevant prior art includes the following references:

| U.S. Pat. No. | | |
|---|---|---|
| (U.S. unless stated otherwise) | Inventor | Issue/Publication Date |
| 2006/0191180 | Williams et al. | Aug. 31, 2006 |
| 7,131,226 | Gray et al. | Nov. 07, 2006 |
| 2005/0005487 | Gray et al. | Jan. 13, 2005 |
| 5,695,346 | Sekiguchi et al. | Dec. 09, 1997 |
| 6,122,850 | Strzeletz | Sep. 26, 2000 |
| 6,598,327 | Strzeletz | Jul. 29, 2003 |
| 6,702,351 | Buring et al. | Mar. 09, 2004 |
| 5,918,924 | Cowan | Jul. 06, 1999 |
| 5,005,893 | McCrary | Apr. 09, 1991 |

### SUMMARY OF THE INVENTION

The primary object of the present invention is to provide a mobile display system and method that permits a user to show a display on a vehicle to a large number of individuals.

Another object of the present invention is to provide a mobile display system and method that permits a user to quickly and easily change a display.

Another object of the present invention is to provide a mobile display system and method that permits a user to show a plurality of displays.

An even further object of the present invention is to provide a mobile display system and method that may be moved from one location to another.

Another object of the present invention is to provide a mobile display system and method that is variable.

The present invention fulfills the above and other objects by providing a mobile display system and method which utilizes a plurality of light emitting diodes (LED's) to create a display located on a side and/or front and/or rear section of a vehicle. The vehicle has a first side, a second side and a rear section and bottom section. The first side is connected along a first edge of the bottom section while the second side is connected along a second edge of the bottom section. A means for powering the at least one display may be batteries, at least one generator, the motor of the vehicle and other power supply means.

The display(s) are preferably connected to at least one computer via a wired or wireless connection. In this manner, a user may program various types of displays, such as advertisements, logos, indicia and the like to be shown, the duration of each display, the intensity, contrast, brightness, refresh rate, dimming rate and other adjustable features of the display(s), into the at least one computer for customization of the display(s) according to the user's preference.

Additional equipment may be utilized in conjunction with the mobile display system of the present invention, including speakers connected to the sides of the vehicle, cameras mounted on the rear section of the vehicle, an alarm, monitors located in the cab of the vehicle to permit a driver and/or passenger to view an area behind the vehicle and the display being shown, and so forth.

To use the vehicle and system of the present invention, a user first turns on the means for powering to provide power to said at least one display and then activates the display. Because the display utilizes light emitting diodes, the life of the display(s) is great, preferably at least 100,000 hours and the electrical power usage is less than incandescent or florescent light sources. In addition, because the light emitting diodes are preferably colored and in motion, the display(s) are more noticeable than traditional billboards or other advertising media.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side perspective plan view of the mobile display system of the present invention;

FIG. 2 is a front view of the mobile display system of the present invention;

FIG. 3 is a rear view of an inside of a bed of a vehicle having the mobile display system of the present invention installed thereon;

FIG. 4 is a front view of a dashboard of a vehicle having the mobile display system of the present invention installed thereon;

FIG. 5 is a front view of a cab interior of a vehicle utilizing the mobile display system of the present invention; and

FIG. 6 is a close-up front view of a display of the mobile display system of the present invention.

### DESCRIPTION OF THE PREFERRED EMBODIMENTS

For purposes of describing the preferred embodiment, the terminology used in reference to the numbered components in the drawings is as follows:
1. mobile display system, generally
2. vehicle
3. first side
4. top section
5. rear section
6. display
7. cab
8. bed floor
9. rack
10. computer
11. ladder
12. tool kit
13. extra parts kit
14. cabinet
15. camera
16. air conditioning unit
17. power outlet
18. reel
19. extension cord
20. alarm
21. compass
22. speaker
23. steering wheel
24. inverter system
25. rearview mirror
26. dashboard
27. monitor for display
28. monitor for camera
29. light emitting diode
30. second side
31. frame
32. vehicle bed
33. bottom section
34. bottom first edge
35. bottom second edge
36. wireless connection
37. means for powering
38. batteries
39. generator
40. motor
41. router
42. wireless air card
43. solar panel
44. front section

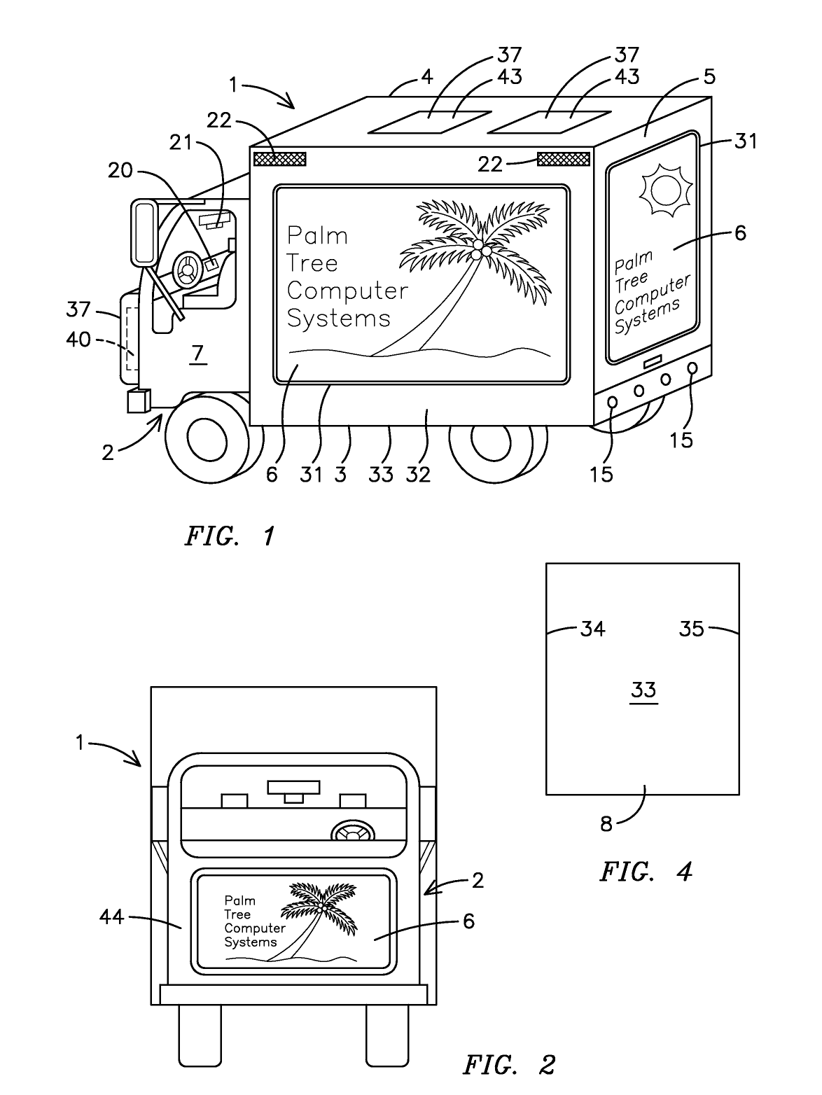

With reference to FIG. 1, a side perspective plan view of the mobile display system of the present invention is shown. The mobile display system, generally 1 of the present invention includes a vehicle 2, preferably having a vehicle bed 32 having a first side 3 and a second side 30 (shown in FIG. 2), a rear section 5, a top section 4 and a bottom section 33. At least one display 6 is preferably located on both sides 3 and 30 of the vehicle 2 and is powered by a means for powering 37, which may be a vehicle motor 40 and/or at least one solar panel 43. The display 6 is preferably surrounded by a frame 31. The display 6 may show various items, such as advertisements, logos, information and the like.

The vehicle 2 includes a cab 2 wherein a driver and at least one passenger may be seated therein. Also located within the cab 2 is preferably a compass 21 and an alarm 20. At least one camera 15 is preferably located on the rear section 5 of the vehicle 2 to permit a driver to view the area behind the vehicle 2 so as to prevent accidents due to poor visibility. At least one speaker 22 may be located on the vehicle 2 exterior so as to permit a user to project sound associated with the display 6.

In FIG. 2, a front view of the mobile display system 1 of the present invention is shown. At least one display 6 may be located on the vehicle front 44 in addition to displays 6 located on the vehicle sides 3 and 30 and on the rear section 5 of the vehicle 2.

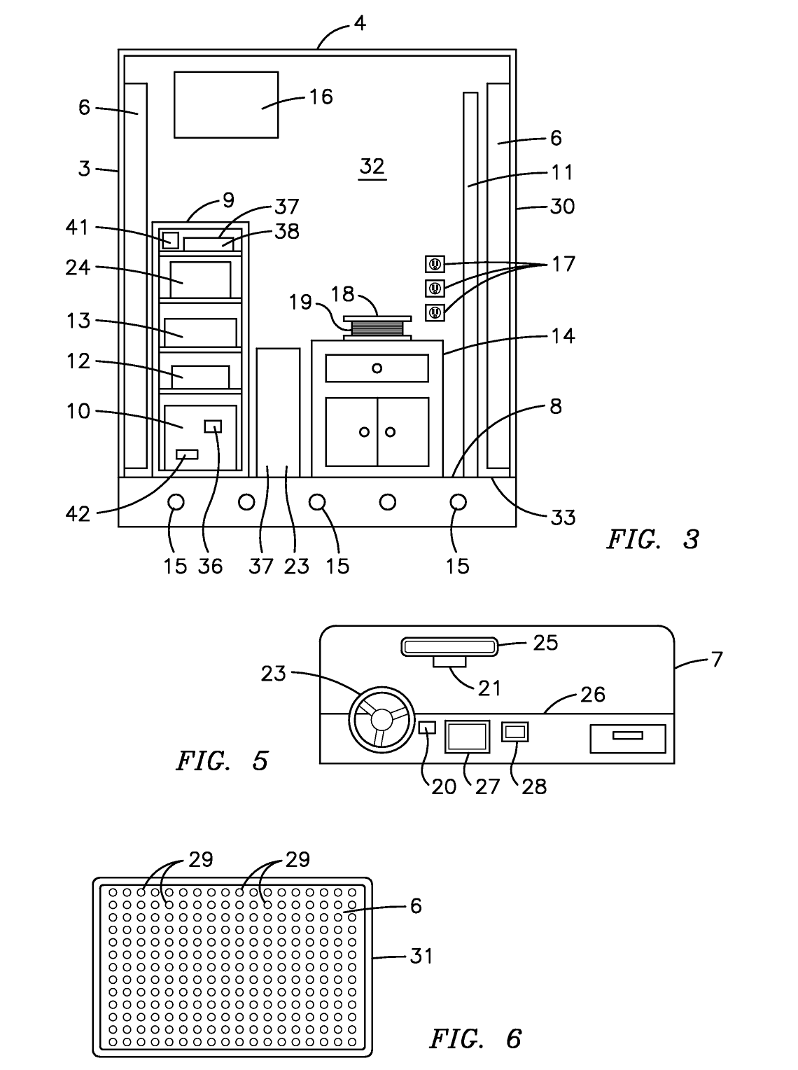

Next, FIGS. 3 and 4 show varying views of an inside of a bed of a vehicle having the mobile display system of the present invention installed thereon. The vehicle bed 32 includes a bottom section 33 having a bed floor 8 wherein the bottom section 33 has a first edge 34 and a second edge 35. Connected along the bottom first edge 34 is the first side 3 and connected along the bottom second edge 35 is the second side 35. Preferably, the first side 3 and the second side 30 are connected to the bottom section 33 at preferably ninety degree angles; however, the sides 3 and 30 may be connected to the bottom section 33 at other angles as well. Located within the vehicle bed 32 are various components used in conjunction with the mobile display system 1 so as to make usage and customization of the display 6 easier.

First, at least one computer 10 is located within the vehicle bed 32 wherein the at least one computer 10 is electrically connected to the at least one display 6 to change the at least one display 6. The at least one computer 10 may be connected to the display(s) 6 via a wired connection or a wireless connection 36. A wireless aircard 42 and router 41 may be used in conjunction with the at least one computer 10. In addition, the at least one computer 10 is preferably located within at least one rack 9, which is also located within the vehicle bed 32.

Second, additional or alternate means for powering 37 may also be located within the vehicle bed 32. The additional or alternate means for powering 37 the display(s) 6 may be at least one generator 39 or at least one battery 38. In addition, at least one extension cord 19 wound on a reel 18 may be provided to permit a user to acquire power from a source external to the vehicle 2.

A ladder 11, tool kit 12, extra parts kit 13, cabinet 14, air conditioning unit 16, which may be located within the vehicle bed 32 or mounted underneath the vehicle 2, power outlet(s) 17, an equinox inverter system 24, preferably having a temperature control to ignite the generator 39 and other tools and/or items, such as, but not limited to, a harness display, wiring harness, fuse kit, generator slide kit, charge outlet, wiring, cable ends, conduits, twist locks and storage boxes, may also be located within the vehicle bed 32 to permit easier use of the mobile display system 1. The items located within the vehicle bed 32 are preferably stored in a plurality of cabinets mounted within the vehicle bed 32 (not shown).

Next, FIG. 5 shows a front view of a cab interior of a vehicle utilizing the mobile display system of the present invention. The cab 7 of the vehicle 2 includes a dashboard 26, rearview mirror 25 and steering wheel 23 as in conventional vehicles 2. However, the cab 7 of a vehicle 2 utilizing the mobile display system 1 of the present invention also includes a monitor for display 27 and a monitor for camera 28. In addition, controls to operate the generator 39 are also preferably located within the cab 7 of the vehicle 2. The monitor for display 27 permits a driver and/or at least one passenger to view the display 6 being shown on the exterior of the vehicle 2. A global positioning system, also known as GPS, may also be located within the cab 7 of the vehicle 2 to monitor the location of the vehicle 2. On the other hand, the monitor for camera 28 permits a driver and/or at least one passenger to view the area located behind the vehicle 2 so as to reduce the amount of accidents caused by poor rearview visibility. The vehicle 2 may also include a camera and wiring for a “live feed” broadcast (not shown).

Finally, FIG. 6 is a close-up front view of a display of the mobile display system of the present invention. Each display 6 is preferably located within a frame 31, although use of a frame 31 is not necessary. The display 6 comprises a plurality of light emitting diodes 29 of various colors. The light emitting diodes 29 per pixel is preferably 2 red, 1 green and 1 blue and the pixel size is preferably 0.67. The light emitting diode 29 lifetime rating is preferably 100,000 hours. The brightness of the display 6 is preferably 6,000 NITs, with a processing between 2-bits to 16-bits and dimming preferably of 5-bits. The refresh rate of the display 6 is preferably 60 frames per second. More than 105,000 lights are utilized in each display 6 with preferably 1,300,000,000 color combinations.

The vehicle 2 may also include a dimming mechanism for use at night.

The use of the present invention mobile display system and method will permit a user to show a display, which may be an advertisement, logo, information and the like, on a vehicle to a large quantity of individuals wherein the display may be quickly and easily changed.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A mobile display system comprising:
a vehicle having a first side, a second side, a front section and a bottom section;
said first side is connected along a first edge of said bottom section;
said second side is connected along a second edge of said bottom section;
at least one display secured to said first side;
said at least one display having a plurality of light emitting diodes; and
a means for powering said at least one display.

2. The mobile display system of claim 1 wherein:
said means for powering said at least one display is at least one battery.

3. The mobile display system of claim 1 wherein:
said means for powering said at least one display is at least one generator.

4. The mobile display system of claim 1 wherein:
said means for powering said at least one display is a vehicle engine.

5. The mobile display system of claim 1 wherein:
said means for powering said at least one display is at least one solar panel.

6. The mobile display system claim 1 further comprising:
a rear section secured to said first side and said second side; and
a top section secured to said first side and said second side such that said top section is a predetermined distance from said bottom section.

7. The mobile display system of claim 6 further comprising:
at least one display secured to said rear section; and
a means for powering said at least one display secured to said rear section.

8. The mobile display system of claim 1 further comprising:
at least one computer connected to said at least one display for permitting a user to change said at least one display.

9. The mobile display system of claim 7 further comprising:
at least one computer connected to said at least one display for permitting a user to change said at least one display.

10. The mobile display system of claim 8 wherein:
said at least one computer to said at least one display connection is wired to permit a user to change said at least one display.

11. The mobile display system of claim 9 wherein:
said at least one computer to said at least one display connection is wired to permit a user to change said at least one display.

12. The mobile display system of claim 8 wherein:
said at least one computer to said at least one display connection is wireless to permit a user to change said at least one display.

13. The mobile display system of claim 9 wherein:
said at least one computer to said at least one display connection is wireless to permit a user to change said at least one display.

14. The mobile display system of claim 1 further comprising:
at least one speaker mounted to said first side.

15. The mobile display system of claim 6 further comprising:
at least one camera secured to said rear section; and
at least one monitor for said at least one camera.

16. The mobile display system of claim 15 further comprising:
at least alarm for indicating when said rear section is adjacent to an object.

17. The mobile display system of claim 1 further comprising:
at least one display secured to said vehicle front section;
said at least one display secured to said vehicle front section having a plurality of light emitting diodes; and
a means for powering said at least one display secured to said vehicle front section.

18. A mobile display system comprising:
a vehicle having a first side, a second side, a front section and a bottom section;
said first side is connected along a first edge of said bottom section;
said second side is connected along a second edge of said bottom section;
a rear section secured to said first side and said second side;
at least one display secured to said rear section;
said at least one display having a plurality of light emitting diodes; and
a means for powering said at least one display.

19. The mobile display system of claim 18 further comprising:
at least one computer connected to said at least one display for permitting a user to change said at least one display.

20. The mobile display system of claim 19 wherein:
said at least one computer to said at least one display connection is wired to permit a user to change said at least one display.

21. The mobile display system of claim 19 wherein:
said at least one computer to said at least one display connection is wireless to permit a user to change said at least one display.

22. The mobile display system of claim 18 wherein:
said means for powering said at least one display is at least one battery.

23. The mobile display system of claim 18 wherein:
said means for powering said at least one display is at least one generator.

24. The mobile display system of claim 18 wherein:
said means for powering said at least one display is a vehicle engine.

25. The mobile display system of claim 18 further comprising:
at least one speaker mounted to said first side.

26. The mobile display system of claim 18 further comprising:
at least one camera secured to said rear section; and
at least one monitor for said at least one camera.

27. The mobile display system of claim 26 further comprising:
at least alarm for indicating when said rear section is adjacent to an object.

28. The mobile display system of claim 18 further comprising:
at least one display secured to said vehicle front section;
said at least one display secured to said vehicle front section having a plurality of light emitting diodes; and
a means for powering said at least one display secured to said vehicle front section.

29. A mobile display system comprising:
a vehicle having a first side, a second side, a front section and a bottom section;
said first side is connected along a first edge of said bottom section;
said second side is connected along a second edge of said bottom section;
a rear section secured to said first side and said second side;
a top section secured to said first side and said second side such that said top section is a predetermined distance from said bottom section;
at least one display secured to said first side;
at least one display secured to said rear section;
said at least one display secured to said first side having a plurality of light emitting diodes;
said at least one display secured to said rear section having a plurality of light emitting diodes;
at least one computer connected to said at least one display for permitting a user to change said at least one display;
a means for powering said at least one display on said first side; and
a means for powering said at least one display secured to said rear section.

30. The mobile display system of claim 28 wherein:
said at least one computer to said at least one display connection is wired to permit a user to change said at least one display.

31. The mobile display system of claim 28 wherein:
said at least one computer to said at least one display connection is wireless to permit a user to change said at least one display.

32. The mobile display system of claim 28 further comprising:
at least one speaker mounted to said first side.

33. The mobile display system of claim 28 further comprising:
at least one camera secured to said rear section; and
at least one monitor for said at least one camera.

34. The mobile display system of claim 32 further comprising:
at least alarm for indicating when said rear section is adjacent to an object.

35. The mobile display system of claim 28 further comprising:
at least one display secured to said vehicle front section;
said at least one display secured to said vehicle front section having a plurality of light emitting diodes; and
a means for powering said at least one display secured to said vehicle front section.

36. A method for showing a display on a mobile display system comprising a vehicle having a first side, a second side, a front section and a bottom section; said first side is connected along a first edge of said bottom section; said second side is connected along a second edge of said bottom section; at least one display secured to said first side; said at least one display having a plurality of light emitting diodes; and a means for powering said at least one display, said method comprising the steps of:
a. turning on said means for powering to provide power to said at least one display; and
b. activating said at least one display.

37. A method for showing a display on a mobile display system comprising a vehicle having a first side, a second side, a front section and a bottom section; said first side is connected along a first edge of said bottom section; said second side is connected along a second edge of said bottom section; a rear section secured to said first side and said second side; at least one display secured to said rear section; said at least one display having a plurality of light emitting diodes; and a means for powering said at least one display, said method comprising the steps of:
a. turning on said means for powering to provide power to said at least one display; and
b. activating said at least one display.

38. A method for showing a display on a mobile display system comprising a vehicle having a first side, a second side, a front section and a bottom section; said first side is connected along a first edge of said bottom section; said second side is connected along a second edge of said bottom section; a rear section secured to said first side and said second side; a top section secured to said first side and said second side such that said top section is a predetermined distance from said bottom section; at least one display secured to said first side; at least one display secured to said rear section; said at least one display secured to said first side having a plurality of light emitting diodes; said at least one display secured to said rear section having a plurality of light emitting diodes; at least one computer connected to said at least one display for permitting a user to change said at least one display; a means for powering said at least one display on said first side; and a means for powering said at least one display secured to said rear section, said method comprising the steps of:
a. turning on said means for powering to provide power to said at least one display; and
b. activating said at least one display.
